(19) United States
(12) Patent Application Publication
(10) Pub. No.: US 2015/0330240 A1
(43) Pub. Date: Nov. 19, 2015

(54) TURBOCHARGER OUTBOARD PURGE SEAL

(71) Applicant: BORGWARNER INC., Auburn Hills, MI (US)

(72) Inventors: Allan KELLY, Hendersonville, NC (US); E. Perry ELLWOOD, Saluda, NC (US)

(21) Appl. No.: 14/652,968

(22) PCT Filed: Nov. 26, 2013
(86) PCT No.: PCT/US2013/071782

§ 371 Date: Jun. 17, 2015

Related U.S. Application Data
(60) Provisional application No. 61/738,231, filed on Dec. 17, 2012.

(51) Int. Cl. F01D 11/00; F02B 39/14; F01D 25/18

(52) U.S. Cl. CPC F01D 11/001; F01D 25/186; F02B 39/14

(57) ABSTRACT

The propensity for oil leakage around the clearance seals of a rotating turbocharger assembly can be minimized by the addition of a variety of sealing systems using an externally pressurized cavity formed between the backface of the compressor wheel and the bearing housing. In one implementation, a pressure plate can be provided. In another embodiment, labyrinth seals can be provided. In addition to these various sealing arrangements, external pressurized air or internally supplied charge air can be selectively supplied to the space behind the pressure plate or labyrinth seal to maintain an inward directed pressure gradient across the seal interface regardless of operating conditions.

### FIELD OF THE INVENTION

Embodiments related in general to turbochargers and, more particularly, to sealing systems for turbochargers.

### BACKGROUND OF THE INVENTION

Turbochargers are a type of forced induction system. They deliver air, at greater density than would be possible in the normally aspirated configuration, to the engine intake, allowing more fuel to be combusted, thus boosting the engine's horsepower without significantly increasing engine weight. A smaller turbocharged engine, replacing a normally aspirated engine of a larger physical size, will reduce the mass and can reduce the aerodynamic frontal area of the vehicle.

FIG. 1 shows a cross-sectional view of a typical turbocharger (10). The turbocharger (10) includes a turbine stage (12) and a compressor stage (14). Turbochargers use the exhaust flow from the engine exhaust manifold to drive a turbine wheel (16), which is located in a turbine housing (17). Once the exhaust gas has passed through the turbine wheel (16) and the turbine wheel (16) has extracted energy from the exhaust gas, the spent exhaust gas exits the turbine housing (17) through an exducer and is ducted to the vehicle downpipe and usually to after-treatment devices such as catalytic converters, particulate traps, and NOₓ traps. The energy extracted by the turbine wheel (16) is translated to a rotational motion that is used to drive a compressor wheel (18), which is located in a compressor cover (19). The compressor wheel (18) draws air into the turbocharger (10), compresses this air, and delivers it to the intake side of the engine. The rotating assembly consists of the following major components: turbine wheel (16); a shaft (20) upon which the turbine wheel (16) is mounted; a compressor wheel (18) also mounted on the shaft (20); an oil flinger (22); and thrust components. The shaft (20) has an associated axis of rotation (21).

The shaft (20) rotates on a hydrodynamic bearing system which is fed a lubricant (e.g. oil) typically supplied by the engine. The bearing system can be provided in a bearing housing (23). The oil is delivered via an oil feed port (24) to feed both journal bearings (26) and thrust bearing (28). Once used, the oil drains to the bearing housing (23) and exits through an oil drain (30) connected to the engine crankcase.

Pressure conditions in the turbine stage (12) and compressor stage (14) can often result in oil being drawn through the sealing mechanisms that seal the rotating assembly to the bearing housing (23). The internal flow of oil from the bearing housing to the backside of the compressor wheel, past the compressor wheel, to the compressor stage and engine combustion chamber is generally referred to as “compressor end oil-passage.” Compressor-end oil passage is to be avoided as it can result in contamination of the catalysts and unwanted emissions. With ever more stringent emissions standards, the propensity for compressor-end oil passage is becoming a greater issue.

Various seal means are commonly used within a turbocharger to create a seal at an interface between one or more static turbocharger elements (e.g. the bearing housing (23) and/or an insert (34)) and a portion of the dynamic rotating assembly (e.g., turbine wheel (16), compressor wheel (18), oil flinger (22), and/or shaft (20)) to minimize the passage of oil from the bearing housing (23) to the compressor stage (14). Such seal means can also prevent the unwanted flow of gas from the compressor stage (12) to the bearing housing (23), a condition known as blowby. FIG. 2 shows a close-up view of a portion of the interface (31) between static and rotating elements in the compressor end of the turbocharger (10). Various sealing elements are used in the area. For instance, one or more clearance seals (32) (e.g. seal rings or piston rings) are operatively positioned between the oil flinger (22) and the insert (34). A portion of each seal (32) can be received within a respective groove (36) provided in the oil flinger (22).

However, during some operating conditions, it may be possible for oil in the bearing housing (23) to pass around the one or more clearance seals (32) and enter the compressor housing (12). One such condition will now be described. There is air in the cavity (40) between the insert (34) and the backface (38) of the compressor wheel (18). The backface (38) of the compressor wheel (18) rotates at high speed about the axis (21). Air in proximity to the rotating backface (38) is forced into like-rotation due to the friction between air and the backface (38). As a result, there can be a centrifugal acceleration (i.e. in the radial direction) which causes there to be a lower pressure in the cavity (40) near the shaft (20) and a higher pressure near the tip (42) of the compressor wheel (18). This pressure gradient is unfavorable with respect to the pressure differential across the interface (31), that is, the pressure on the outboard side (31o) is lower than the pressure on the inboard side (31i), potentially causing compressor-end oil passage.

In this condition, there is a flow (44) of oil from the cavity (46) between the thrust bearing (28) and the insert (34), around the one or more seal rings (32). This flow (44) is drawn by the forced vortex, as described above, to become a flow (48) behind the compressor wheel backface (38). This flow (48) is drawn through the compressor stage diffuser (50) (see FIG. 1). Typically, the effect of this reduced pressure, or even negative pressure (vacuum), can be counteracted by mechanically recessing the compressor wheel (18) in the bearing housing (23). As a result of this arrangement, some pressurized air from the compressor stage (14) may be diverted to the cavity (40) behind the compressor wheel (18). This diversion of compressed air alters the pressure balance around the cavity (40) from the compressor wheel tip (42) to the one or more seals (32) and minimizes the potential for this oil passage into the compressor discharge and then the combustion system of the engine.

An inward directing pressure gradient (relative to the bearing housing) is effective for normal operating conditions with substantial compressor outlet pressure. However, there are some operating conditions in which it is more difficult or impossible to maintain a positive pressure on the outboard side of the seal including: low or zero turbo speed, restricted compressor inlet, exhaust braking or start-up of the low pressure stage in a two stage sequential turbine system. In such cases, it may be possible for oil or other lubricant (44) to pass around the one or more seals (32). Some of these examples will be presented in greater detail below.

When a heavily laden truck, equipped with an engine compression type exhaust brake, is traveling down a grade with a long steady incline, the exhaust brake can be used to block the flow of exhaust gas downstream of the turbine wheel (16) and provide retardation to the vehicle, independent of the vehicle's wheel brakes. The mass and inertia of the truck can push the truck down the hill, which forces rotation of the engine through the vehicle gearbox. With no fuel being introduced into the engine, the engine acts like an air pump against the blockage of the exhaust brake to retard the velocity of the truck. The mass flow of gas through the turbine stage is greatly reduced, so the rotational speed of the turbocharger wheels is not predominantly driven by the turbine stage.

The braking effect of the vehicle on the engine (through the vehicle gearbox), which is now acting as an air pump, can generate a depression (e.g. a vacuum) in the inlet system as it draws air through the compressor stage (14). The depression in the compressor stage (14) alters the pressure differential at the tip (42) of the compressor wheel (18) across the compressor-end seal(s) (32). This results in an unfavorable pressure differential across the seal rings (32) which can result in compressor-end oil passage. When this exhaust brake-driven situation arises, the depression that has developed can overpower the typically used seal ring pressure differential fixes (e.g. recessing the compressor wheel (18)) and cause the passage of oil from the bearing housing (23) into the compressor discharge, and then to the engine combustion system.

A similar problem can occur with the high pressure (HP) compressor stage in staged turbochargers in which the compressors are arranged in series. In a series compressor configuration, the discharge of the low pressure (LP) compressor is ducted directly to the inlet of the high (HP) compressor. When the exhaust mass flow is directed to the turbine stage of the smaller, high pressure (HP) turbocharger (i.e., not to the larger turbine stage of the LP turbocharger), the compressor stage of the HP compressor can draw more mass flow of air into its inlet than the mass flow output of the potentially larger capacity low pressure (LP) compressor, which is running slowly, with less mass flow output than the mass flow input of the smaller HP compressor. The result being that the compressor stage of the LP compressor is running in a depression, which can result in an unfavorable pressure differential across the compressor-end seal ring of the HP turbocharger.

Thus, there is a need for enhanced sealing arrangements between the rotating components and the static components in the compressor-end of a turbocharger, particularly at low turbocharger speeds.

### SUMMARY OF THE INVENTION

Embodiments relate to sealing elements and arrangements between the backface of the compressor wheel and neighboring components, such as the bearing housing and/or the insert. Such sealing elements and arrangements can improve the seal between the dynamic rotating assembly components and the complementary static components on the compressor-end of a turbocharger, thereby minimizing compressor-end oil passage. The sealing elements can include a pressure plate and/or labyrinth seals. The sealing elements can be operatively positioned in a cavity defined between the backface of the compressor wheel and neighboring components. In at least some instances, external pressurized air or internally supplied charge air can be selectively supplied to a space behind the sealing elements to maintain an inward directed pressure gradient regardless of operating conditions.

### BRIEF DESCRIPTION OF THE DRAWINGS

Embodiments are illustrated by way of example and not limitation in the accompanying drawings in which like reference numbers indicate similar parts and in which:

FIG. 1 is a cross-sectional view of a typical turbocharger;

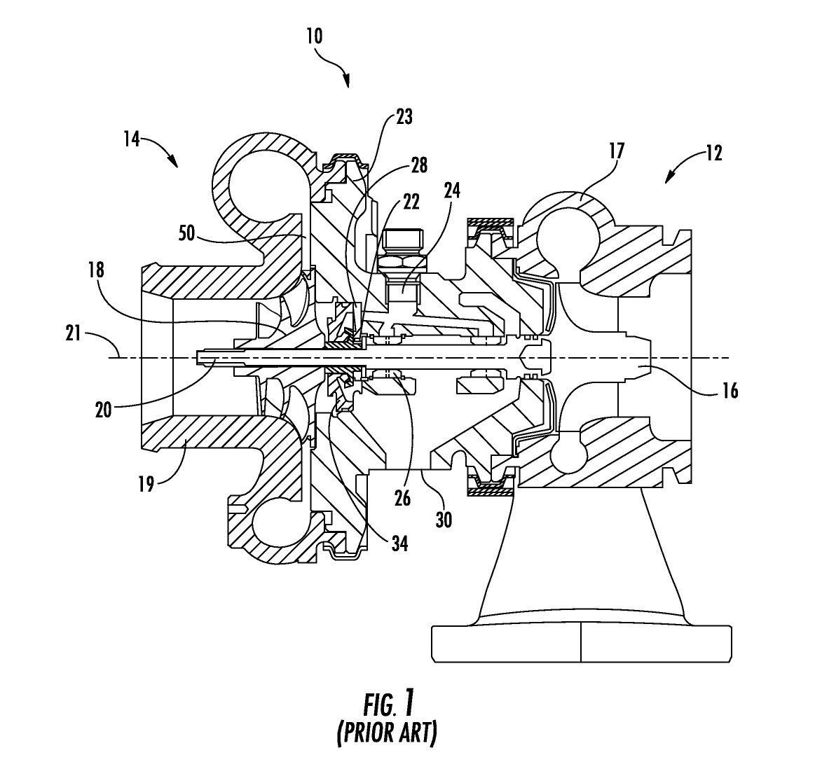

FIG. 2 is a close up view of a portion of the compressor-end of a typical turbocharger;

FIGS. 3A-B show a first sealing arrangement between rotating and static components in the compressor-end of a turbocharger;

FIGS. 4A-C show examples of various configurations of the pressure plate of FIGS. 3A-B;

FIGS. 5A-B show a second sealing arrangement between rotating and static components in the compressor-end of a turbocharger;

FIGS. 6A-B show a third sealing arrangement between rotating and static components in the compressor-end of a turbocharger;

FIGS. 7A-C show examples of various sealing configurations between a backface of a compressor wheel and a pressure plate of FIGS. 6A-B; and

FIG. 8 shows another example of a sealing configuration between a backface of a compressor wheel and a pressure plate.

### DETAILED DESCRIPTION OF THE INVENTION

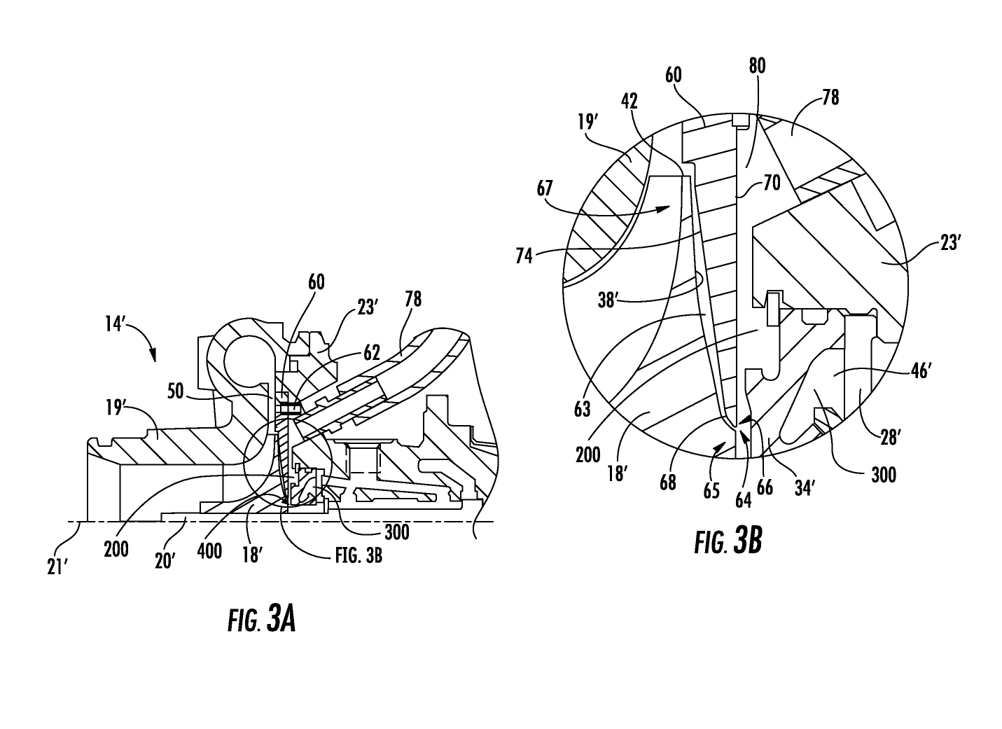

Arrangements described herein relate to sealing systems and methods for use between the dynamic rotating assembly components and the complementary static components on the compressor-end of a turbocharger. More particularly, embodiments herein are directed to forming sealing systems that can maintain a positive pressure on the outboard side of the conventional clearance seal (e.g. piston seal rings) interface to prevent oil leakage. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Arrangements are shown in FIGS. 3-8, but the embodiments are not limited to the illustrated structure or application.

FIGS. 3A-3B show one example of a sealing arrangement between a portion of the rotating assembly (e.g., turbine wheel (not shown in FIGS. 3A-3B), compressor wheel (18′), oil flinger (22′), and/or shaft (20′)) and one or more static turbocharger elements (e.g. the bearing housing (23′) and/or an insert (34′)) in the compressor-end of a turbocharger. More particularly, FIGS. 3A-3B show a sealing system in which a pressure plate (60) can be provided in the volume between the backface (38′) of the compressor wheel (18′) and the bearing housing (23′) and/or associated bearing housing components. The pressure plate (60) can be attached to the bearing housing (23′) in any suitable manner, including, for example, by one or more fasteners (62) and/or mechanical engagement. Such attachment can be made in one or more suitable locations. In one embodiment, the pressure plate (60) can be attached to the bearing housing (23′) near the tip (42′) of the compressor wheel (18′). The pressure plate (60) can be made of any suitable material, including, for example, steel, aluminum, titanium or a high temperature polymer such as polyetheretherketone (PEEK), polyaryletherketone (PAEK), or polyamide. The use of softer polymers can help to avoid damage to the compressor wheel (18′) if light contact with the pressure plate (60) occurs. The pressure plate (60) can be formed in any suitable manner, such as by stamping and/or Machining.

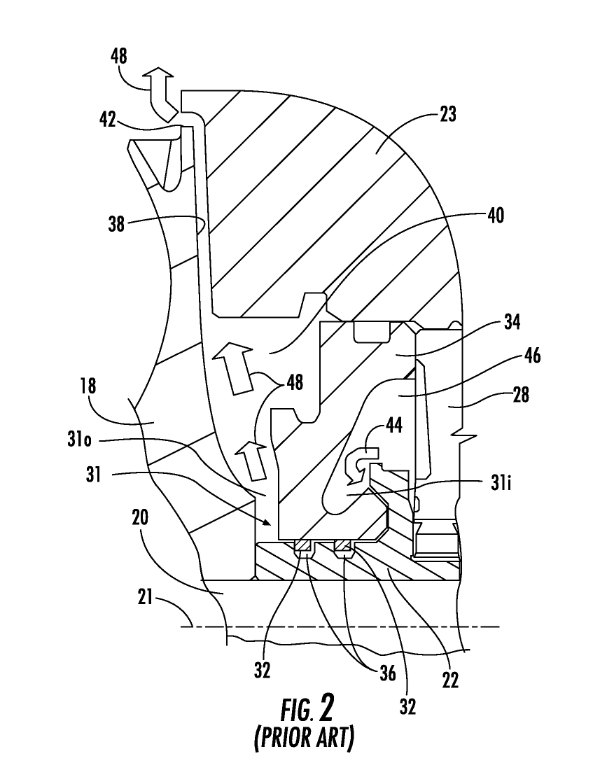

The pressure plate (60) can help to isolate a clearance seal interface (400) from the effects of the region behind the compressor wheel (18′), which, as described above, can unfavorably alter the pressure differential across the clearance seals (32′) at least with respect to compressor-end oil passage. With the inclusion of the pressure plate (60), the prior cavity (40) (see FIG. 2) can be divided into a first volume (63) and a second volume (80). The first volume (63) can be formed between the compressor wheel backface (38) and pressure plate (60), and the second volume (80) can be formed between the pressure plate (60) and one or more stationary elements (e.g., the bearing housing (23), insert (34), etc.) and/or one or more rotating elements. The first and second volumes (63, 80) can extend circumferentially about the axis (21).

The first and second volumes (63, 80) can be in fluid communication by a narrow or restricted outlet passage (64). The outlet passage (64) can be formed between the radially inner end (71) (e.g., a tip (66)) of the pressure plate (60) and the backface (38′) of the rotating compressor wheel (18′) and, more particularly, with a radially inner region (65) of the backface (38′) of the compressor wheel (18′). Such a narrow outlet passage (64) can cause aerodynamic choking of the flow of purge gas therethrough. The passage (64) may also be at least partially defined between a compressor side surface (74) of the pressure plate (60) and a radially outer region (67) of the backface (38′) of the compressor wheel (18′). The terms “radially inner” and “radially outer” as used herein are made with respect to the axis (21′) of the shaft (20′).

The pressure plate (60) can be a generally annular component. The pressure plate (60) can include a compressor-side surface (74) and a back surface (70). The pressure plate (60) can include a radially inner end (71) forming an inner diameter. The radially inner end (71) can be defined at least in part by the tip (66). In one embodiment, the thickness of the pressure plate (60) can increase in the radially outward direction. Thus, the thickness of the pressure plate (60) is smallest at or near the tip (66), and the thickness of the pressure plate (60) can increase therefrom when moving in the radially outward direction, as can be seen in FIG. 3B. However, the pressure plate (60) shown in FIGS. 3A-3B is merely an example, and embodiments of the pressure plate (60) are not limited to such a configuration. For instance, the pressure plate (60) can have a different taper than what is shown, or it can have a substantially uniform thickness or other non-tapered configuration.

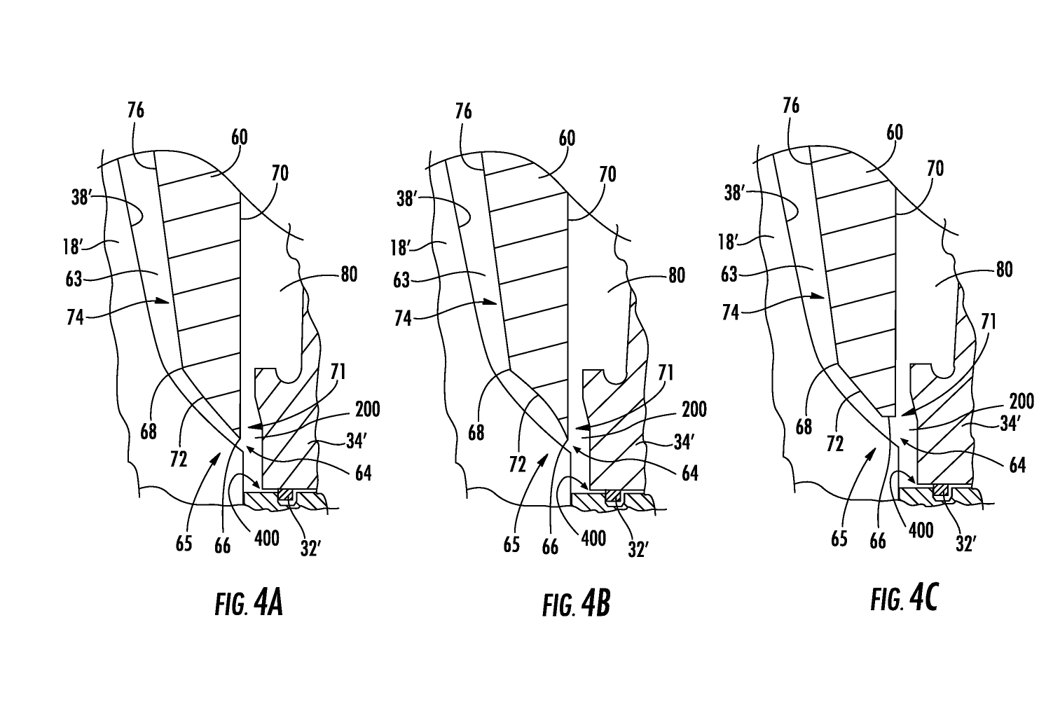

The pressure plate (60) and the interface between the tip (66) of the pressure plate (60) and the backface (38′) of the rotating compressor wheel (18′) can have any suitable configuration to minimize the leakage of a purge gas supplied to the second volume (80). FIGS. 4A-C show examples of various possible configurations of the pressure plate (60). These configurations can facilitate the introduction of turbulent flow to enter the narrow passage (64) to impede the flow of air through the outlet passage (64). In one embodiment, the radial clearance between the tip (66) of the pressure plate (60) and the backface (38′) of the rotating compressor wheel (18′) can be in the range of about 0.35 to about 0.70 mm. The radial clearance can be selected to balance close fit to minimize purge gas leakage while allowing for normal rotor motion without contact. Such configurations include variations to the tip (66) of the pressure plate (60) and/or an edge (68). The tip (66) can be formed by the intersection of a back surface (70) of the pressure plate (60) with a radially inner portion (72) of a compressor-side surface (74) of the pressure plate (60). The edge (68) can be formed at a transition between the radially inner portion (72) and a radially outer portion (76) of the compressor-side surface (74).

In one implementation, the tip (66) can be defined by an acute angle, as is shown in FIG. 4A. This angle can be as sharp an angle as possible to force separation of the airflow flowing from the tip (66) of the pressure plate (60) toward the tip (42) of the compressor wheel (18). For instance, the angle can be about 60 degrees or less, about 45 degrees or less, about 30 degrees or about 15 degrees or less, just to name a few possibilities. In this implementation, the radially inner portion (72) of the compressor-side surface (74) can be generally flat. As a result, since the pressure plate (60) is an annular component, the radially inner portion (72) can be generally conical.

Another implementation of the pressure plate (60) is shown in FIG. 4B. Here, the radially inner portion (72) of the compressor-side surface (74) can be generally concave. Such concavity can facilitate making the angle of the tip (66) as acute as possible. Such concavity of the radially inner portion (72) can help to make the angle of the edge (68) as sharp as possible.

Still another implementation of the pressure plate (60) is shown in FIG. 4C. In this implementation, the tip (66) of the pressure plate (60) can be chamfered. A chamfer can provide another edge with the potential for flow separation and also providing a relatively easier to manufacture intersection.

In some implementations, the second volume (80) can be selectively pressurized to produce an inward directed pressure gradient across the seal interface (400) to prevent oil or other lubricant from exiting the bearing housing (23). An “inward directed pressure gradient” means that the pressure on the outboard side (200) of the interface (400) is greater than the pressure on the inboard side (300). The outboard side (200) is the side of the interface (400) that is closer to the compressor wheel (18). The inboard side (300) is the side of the interface that is closer to the bearing housing (23).

The inboard side (300) can include at least the cavity (46′) between the insert (34′) and the thrust bearing (28′). The outboard side (200) includes the volume (80). Again, the second volume (80) can be selectively pressurized to maintain, as desired, a predetermined target pressure so as to maintain an inward directed pressure gradient across the seal interface (400). The pressure of the inboard side (300) is typically about atmospheric pressure (1 bar), and it can be influenced by the crankcase pressure. The target pressure of the second volume (80) can be at any suitable pressure so that an inward directed pressure gradient is achieved. In one embodiment, the target pressure of the second volume (80) can be from at least about 100 millibars to about 150 millibars greater than the pressure of the inboard side (300).

In order to maintain the desired target pressure in the second volume (80) or a desired pressure ratio across the seal interface (400), the loss of air from the second volume (80) can be minimized. In doing so, the amount of air supplied to the second volume (80) to produce the desired target pressure in minimized, thereby conserving purge gas (e.g. air) for other beneficial purposes. Excessive amounts of purge gas supplied to the second volume (80) can result in cost or performance penalties. Accordingly, the configuration of the radially inner end (71) of the pressure plate (60) (e.g., the tip (66)) and/or the outlet passage (64) can be optimized to minimize the leakage of air from the second volume (80) to the first volume (63). The radially inner end (71) of the pressure plate (60) can have any suitable configuration, examples of which are described herein.

As noted above, the second volume (80) can be selectively pressurized in at least some implementations. Such selective pressurization of the second volume (80) can be achieved in any suitable manner. As an example, a supply line (78) can be provided to supply air or other suitable fluid to the volume (80) formed between the pressure plate (60) and the bearing housing (23), as is shown in FIGS. 3A-B. Again, the second volume (80) can be in fluid communication with the first volume (63) by way of the narrow passage (64). The supply line (78) can be routed through a portion of the bearing housing (23). Purge gas (e.g. pressurized air) or other pressurized fluid may be supplied to the second volume (80) under some operational conditions. The fluid can be supplied from any suitable source, including external pressurized air or internally supplied charge air source. For instance, the source can be a dedicated electric pump, diverted from some point in the vehicle system (e.g., the braking system), or even from another portion of the turbocharger. When the fluid is supplied to the second volume (80), an inward directed pressure gradient can be provided regardless of operating conditions.

The supply of air to the second volume (80) can be selectively implemented in any suitable manner. For instance, a controller (not shown) can be operatively connected to selectively control the supply of pressurized fluid to the volume (80). The controller can be an engine controller, a turbocharger controller or other suitable controller. The controller can be comprised of hardware, software or any combination thereof.

Air or other purge gas can be selectively supplied to the volume (80) when the pressure on the outboard side (200) of the interface (400) is at or below a predetermined target pressure. Alternatively or in addition, air or other purge gas can be selectively supplied to the volume (80) when the pressure differential and/or pressure ratio between the outboard side (200) and the inboard side (300) of the interface (400) is at or below a predetermined target ratio or differential. If such conditions occur, air or other purge gas can be supplied to the second volume (80) to raise the pressure of the outboard side (200) to an acceptable level. Examples of operational conditions when such may arise include idle or when the engine is running at light load. Once the predetermined target pressure, differential and/or ratio is achieved, the supply of air to the volume (80) can be discontinued. In this way, air consumption can be minimized, that is, it does not have to be taken from beneficial use elsewhere.

However, it should be noted that, in other implementations, the second volume (80) may not be selectively pressurized. Again, the pressure plate (60) can help to isolate the clearance seal interface (400) from effects of the region behind the compressor wheel (18′), which can otherwise adversely affect the pressure differential across the clearance seals (32′) at least with respect to compressor-end oil passage. For instance, in one test of a turbocharger system with the pressure plate (60), compressor-end oil passage still occurred, but it occurred at a pressure differential of 200-300 millibars across the interface (400), that is, the pressure of the inboard side (300) is greater than the pressure of the outboard side (200) by 200-300 millibars. In contrast, without the pressure plate (60), compressor-end oil passage typically occurs at any point when the pressure of the inboard side (300) is greater than the pressure of the outboard side (200). Thus, the inclusion of the pressure plate (60) can expand the range of suitable pressure differentials across the interface (400) without experiencing compressor-end oil passage. It should be noted that embodiments in which selective pressurization of the outboard side (200) of the interface (400) is not implemented may be applied to any of the arrangements described herein.

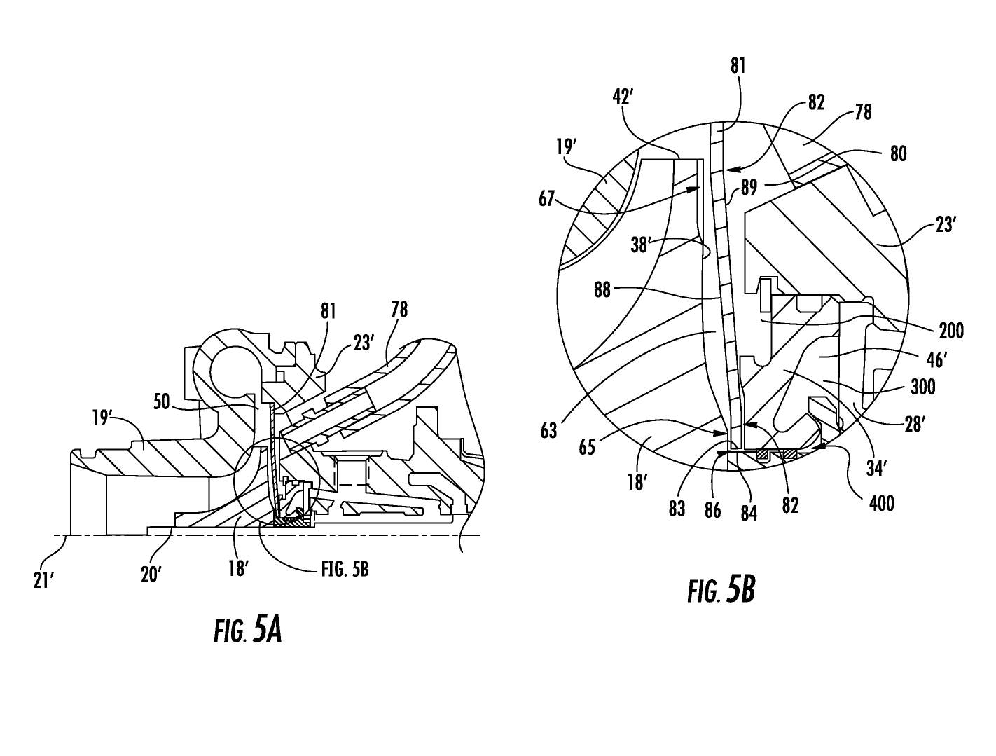

FIGS. 5A-5B shows a sealing system in which a pressure plate (81) can be provided in the volume between the backface (38′) of the compressor wheel (18′) and the bearing housing (23′) and/or associated bearing housing components. The above discussion of pressure plate (60) can apply equally to pressure plate (81). Here, the pressure plate (81) can be thin-walled. The pressure plate (81) can have a thickness from about 0.5 millimeters to about 3 millimeters. In one embodiment, the pressure plate (81) can be about 1 millimeter thick. The thickness of the pressure plate (81) can be generally constant in the radially outward direction. The pressure plate (81) may include one or more bends (82) therein. The pressure plate (81) can be formed in any suitable manner, such as by stamping, turning, casting, or injection molding processes.

A radially inner end or tip (83) of the pressure plate (81) can define a restricted flow passage (86) with an outer peripheral surface (84) of the oil flinger (22′). Alternatively or in addition, the flow passage (86) can be at least partially defined between a compressor side (88) surface of the pressure plate (81) and a radially outer region (67) and/or a radially inner region (65) of the backface (38′) of the compressor wheel (18′). The pressure plate (81) can generate a restriction in the effect of the forced vortex in the prior cavity (40) (see FIG. 2), which can in turn alter the pressure differential across the one or more seal rings (32′).

When the engine generates a depression in the compressor cover (19′), as described above, oil can be drawn around the seal rings (32′) into the first volume (63) between the backface (38′) of the compressor wheel (18′) and the compressor-side surface (88) of the thin section pressure plate (81). The tip (83) of the thin walled pressure plate (81) can be located as close as possible to the outer peripheral surface (84) of the oil flinger (22′) to as to minimize the passage (86) therebetween. The difference in diameter between the tip (83) of the thin section pressure plate (81) and the diameter of the outer peripheral surface (84) of the oil flinger (22′) may be sized based on the clearance required due to both the tilt of the rotating assembly and the orbital nature of the rotating of the rotating assembly. It will be appreciated that, the greater the clearance at the tip (83), the greater the propensity for purge gas to pass this restricting passage (86). Moreover, a greater amount of air may be necessary to produce the desired target pressure on the outboard side (200) of the interface (400) (e.g. from at least about 100 to about 150 millibars). However, if the clearance is made smaller, there is a greater chance of the moving (e.g., rotating, orbiting, and tilting) oil flinger (22′) making contact with the stationary tip (83) of the pressure plate (81).

The system can include a supply line (78) to supply air or other suitable fluid to cavity volume (80) formed between the pressure plate (81) and the bearing housing (23′), as is shown in FIGS. 5A-B. The above discussion of the supply line (78) made in connection with FIGS. 3A-B is equally applicable here.

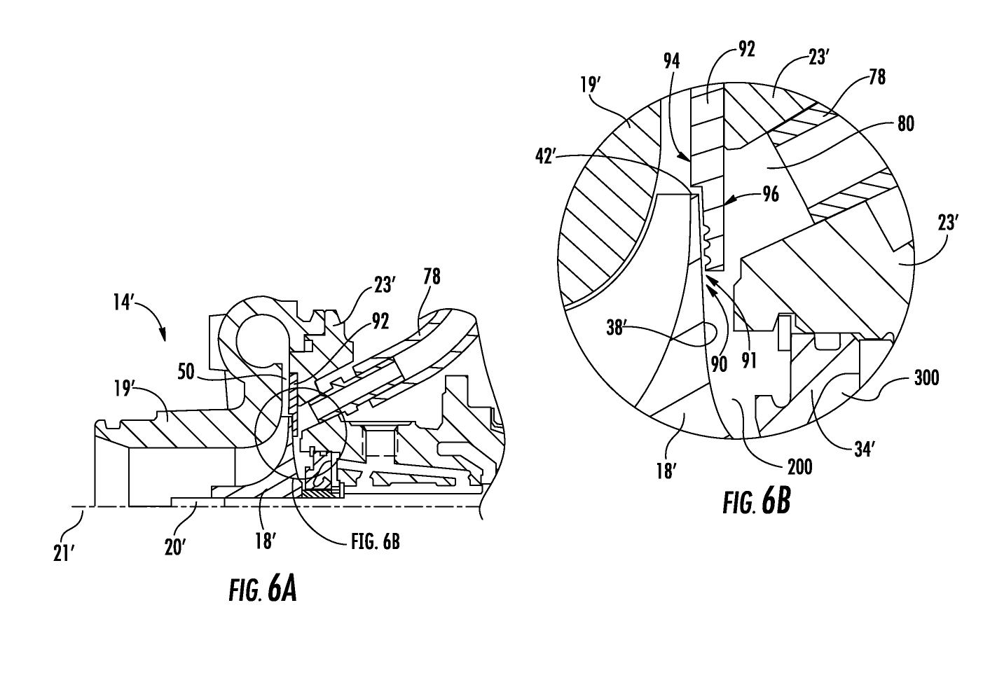

FIGS. 6A-6B shows a sealing system in which a restricted passage (91) is formed at least in part by a labyrinth seal (90). The labyrinth seal (90) can be used to generate an aerodynamic restriction against the flow of purge gas from the one or more seal rings (32′) to the tip (42′) of the compressor wheel (18′). The labyrinth seal (90) can change the available static pressure head into turbulent kinetic energy across each constriction formed by the labyrinth seal (90). The high degree of turbulence can reduce the amount of flow that can move though each chamber of the labyrinth seal (90).

The labyrinth seal (90) can be formed in any suitable manner. For example, a pressure plate (92) can be provided in a portion of the volume between the backface (38′) of the compressor wheel (18′) and the bearing housing (23′) and/or associated bearing housing components. The pressure plate (92) can be attached to the bearing housing (23′) in any suitable manner, including, for example, by one or more fasteners and/or mechanical engagement. Such attachment can be made in one or more suitable locations. The pressure plate (92) can be made of any suitable material, including, for example, steel. The pressure plate (92) can be a generally annular component. The pressure plate (92) can include a compressor-side surface (94) and a back surface (96). The pressure plate (92) can include a radially inner end (98) forming an inner diameter.

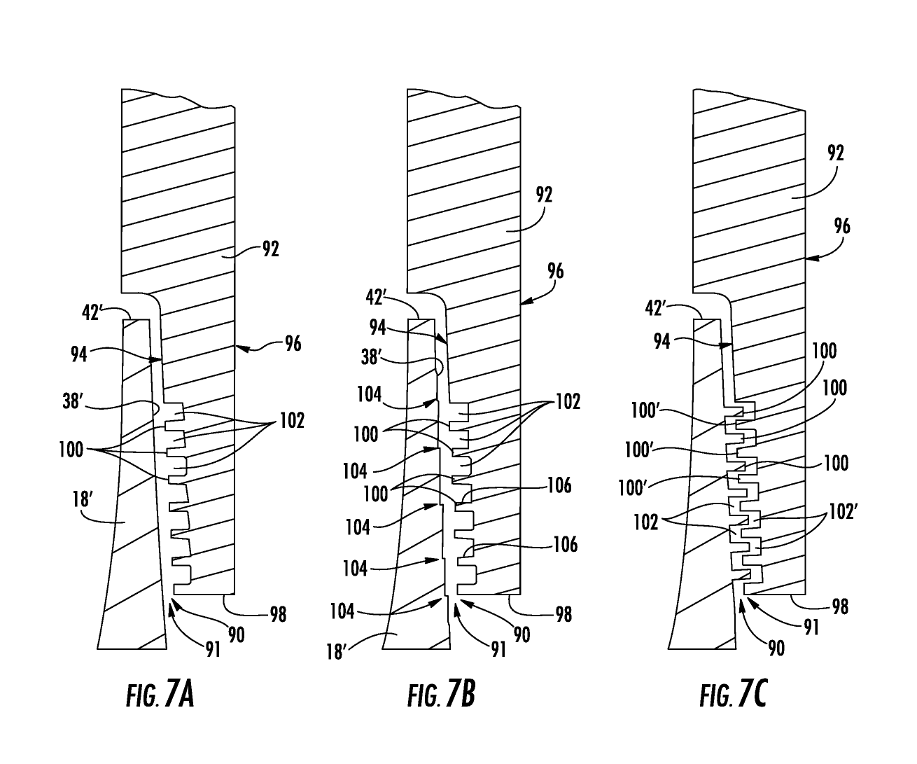

FIGS. 7A-C show examples of various possible configurations of the labyrinth seal (90). Each of these configurations will be considered in turn below.

In one implementation, a plurality of teeth (100) can be formed in compressor-side surface (94) of the pressure plate (92) and the backface (38′) of the compressor wheel (18′) can be generally smooth, as is shown in FIG. 7A. The teeth (100) can generally extend along the axial direction, that is, generally in the direction of the axis (21′). Of course, the teeth (100) extend circumferentially as well about the axis (21′). A labyrinth chamber (102) can be formed at least in part between neighboring pairs of teeth (100). The labyrinth chambers (102) extend circumferentially about the axis (21′).

There can be any suitable quantity of teeth (100). The teeth (100) can be distributed along the surface (94) in any suitable manner. For instance, the teeth (100) can be substantially equally spaced. In some instances, the spacing between at least one pair of teeth (100) may be unequal to the spacing between other pairs of teeth (100). Naturally, the quantity and spacing of the labyrinth chambers (102) depends at least partially on the quantity and spacing of the teeth (100).

The teeth (100) can have any suitable conformation that forms alternating regions of larger and smaller volumes along the radial direction. In one embodiment, the teeth (100) can be generally rectangular in cross-sectional shape. However, other conformations are possible. The teeth (100) can extend the same axial distance, or one or more of the teeth (100) can extend a different axial distance than the other teeth (100). The conformation of the labyrinth chambers (102) depends at least partially on the conformation of the teeth (100). The plurality of labyrinth chambers (102) may be substantially identical to each other, or one or more of the labyrinth chambers (102) can be different from the other labyrinth chambers in one or more respects. In one embodiment, the depth of the labyrinth chambers (102) can be approximately equal to the width of the labyrinth chambers (102), and the width of the tooth (100) can be approximately half the width of the labyrinth chamber (102).

It will be understood that the opposite arrangement to that shown in FIG. 7A can be provided. In such case, the plurality of teeth (100) can be formed in the backface (38′) of the compressor wheel (18′), and the compressor-side surface (94) of the pressure plate (92) and can be generally smooth.

In another implementation of the labyrinth seal (90), a plurality of teeth (100) can be formed in the compressor-side surface (94) of the pressure plate (92), and the backface (38′) of the compressor wheel (18′) can include a plurality of steps (104), as is shown in FIG. 7B. The discussion of the teeth (100) and labyrinth chambers (102) above in connection with FIG. 7A applies equally to the teeth and chambers (102) in FIG. 7B. The steps (104) can have any suitable configuration, spacing and arrangement. There can be any suitable quantity of steps (104). The steps (104) can be substantially identical to each other, or at least one of the steps (104) can be different from the other steps (104) in one or more respects. The steps (104) may or may not be arranged relative to the teeth (100). In one embodiment, the teeth (100) and/or the floors (106) of the chambers (102) in the pressure plate (90) can be stepped in a manner complementary to that used on the steps (104) on the compressor wheel (18). For instance, as is shown in FIG. 7B, the floors (106) of every other chamber (102) can be substantially aligned with a respective one of the steps (104).

It will be understood that the opposite arrangement to that shown in FIG. 7B can be provided. In such case, the plurality of teeth (100) can be formed in the backface (38′) of the compressor wheel (18′), and the compressor-side surface (94) of the pressure plate (92) can include a plurality of steps.

In a further variation, a staggered labyrinth seal (90) can be provided, as is shown in FIG. 7C. In such case, a plurality of teeth (100) can be formed in the backface (38′) of the compressor wheel (18′), and a plurality of teeth (100′) can be formed in the compressor-side surface (94) of the pressure plate (92). The discussion of the teeth (100) and labyrinth chambers (102) above in connection with FIG. 7A applies equally to the teeth (100, 100′) and chambers (102, 102′) in FIG. 7C. The teeth (100) and/or labyrinth chambers (102) in the backface (38′) of the compressor wheel (18) can be substantially equal to the teeth (100′) and/or labyrinth chambers (102′) formed in the compressor-side surface (94) of the pressure plate (92). However, one or more of the teeth (100) and/or labyrinth chambers (102) in the backface (38′) of the compressor wheel (18′) can be different from the teeth (100′) and/or labyrinth chambers (102′) in the compressor-side surface (94) of the pressure plate (92) in one or more respects.

The system can be arranged such that each labyrinth chamber (102′) in the pressure plate (92) can receive a respective one of the teeth (100) in the backface (38) of the compressor wheel (18′). Likewise, each labyrinth chamber (102) in the backface (38′) of the compressor wheel (18′) can receive a respective one of the teeth (100′) in the pressure plate (92). The teeth (100) provided on the backface (38′) of the rotating compressor wheel (18′) can cause there to be relative motion between the surfaces of the teeth (100) and the surfaces of the static labyrinth chambers (102′) provided on the pressure plate (92), for which there can be a viscosity effect that tends to force any fluid therebetween into a rotating motion, thereby causing turbulence. Further, the arrangement of interlaced teeth (100, 100′) can also increase the length of the seal passage and create a tortuous path. These effects can produce more resistance to efficient flow therethrough.

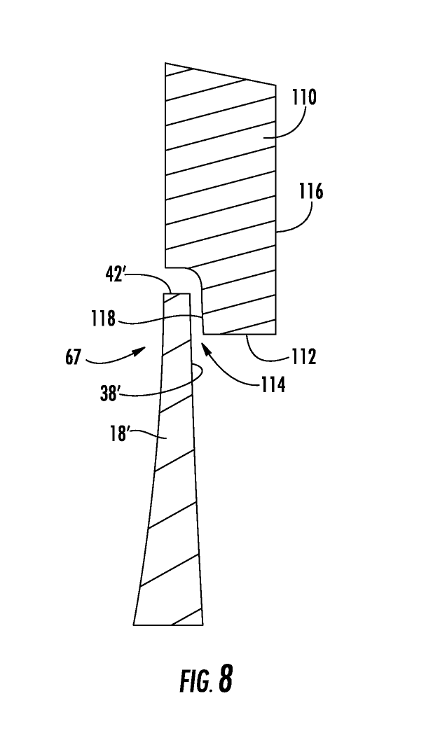

FIG. 8 shows an arrangement in which a pressure plate (110) is provided. The pressure plate (110) can be relatively short in the radial direction such, when it is installed in its operational position, its radially inner end (112) terminates in a radially outer region (67) of the backside (38′) of the compressor wheel (18′). The pressure plate (110) can be attached to the bearing housing (23′) in any suitable manner, such as by fasteners and/or mechanical engagement. The pressure plate (110) can include a radially inner end (112). The pressure plate (110) can include a back surface (116) and a compressor side surface (118). A restricted flow passage (114) can be formed between the compressor side surface (118) of the pressure plate (110) and the backside (38′) of the compressor wheel (38′).

The system can include a supply line (not shown) to supply air or other suitable fluid to cavity volume (80) formed between the pressure plate (110) and the bearing housing (23′). The above discussion of the supply line (78) made in connection with FIGS. 3A-B is equally applicable here with respect to FIG. 8.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

Aspects described herein can be embodied in other forms and combinations without departing from the spirit or essential attributes thereof. For instance, while embodiments described herein are directed to compressor end oil passage, it will be appreciated that such sealing systems and methods can be applied to minimize turbine end oil discharge (i.e., the passage of oil from the bearing housing to the turbine stage). Thus, it will of course be understood that embodiments are not limited to the specific details described herein, which are given by way of example only, and that various modifications and alterations are possible within the scope of the following claims.

What is claimed is:

1. A sealing system for the compressor end of a turbocharger comprising:
a rotating assembly including a shaft (20′) having axis of rotation (21′) and a compressor wheel (18′) mounted on the shaft (20′), the compressor wheel (18′) including a backface (38′); a bearing housing (23′), a portion of the shaft (20′) being received in the bearing housing (23′);
one or more seals (32′) operatively positioned in an interface (400) between one or more static turbocharger elements and the rotating assembly, whereby the one or more seals (32′) minimize oil passage from the bearing housing across the interface (400); and
a generally annular pressure plate (60, 81, 110) operatively positioned between the backface (38′) of the compressor wheel (18′) and the bearing housing (23′), a volume (80) being defined between at least the pressure plate (60, 81, 110) and the bearing housing (23′), the volume (80) having a restricted flow outlet passage (64, 86, 114), whereby the interface (400) is substantially isolated from the effects of a region behind the compressor wheel.

2. The sealing system of claim 1, wherein the pressure plate (60, 81, 110) is attached to the bearing housing (23′).

3. The sealing system of claim 1, further including a supply line (78) in fluid communication with the volume (80), whereby a pressurized fluid is selectively supplied to the volume (80) via the supply line (78) to maintain an inward directed pressure gradient across the interface (400) to prevent oil leakage from the bearing housing (23′).

4. The sealing system of claim 1, wherein the reduced flow passage (64) is defined between a radially inner end (71) of the pressure plate (60) with a radially inner region (65) of the backface (38′) of the compressor wheel (18′).

5. The sealing system of claim 4, wherein the radially inner end (71) of the pressure plate (60) is defined by a tip (66) formed by an acute angle between a compressor-side surface (74) and a back surface (70) of the pressure plate (60).

6. The sealing system of claim 4, wherein the radially inner end (71) of the pressure plate (60) is defined by a chamfer.

7. The sealing system of claim 1, wherein the restricted flow passage (64, 86, 114) is at least partially defined between a compressor side surface (74, 88, 118) of the pressure plate (60, 81, 110) with a radially outer region (67) of the backface (38′) of the compressor wheel (18′).

8. The sealing system of claim 1, further including an oil flinger (22′) mounted on the shaft (20′), wherein the restricted flow passage (86) is defined at least in part between the an outer peripheral surface (84) of the oil flinger (22′) and a radially inner end (83) of the pressure plate (81).

9. A sealing system for the compressor end of a turbocharger comprising:
a rotating assembly including a shaft (20′) having axis of rotation (21′) and a compressor wheel (18′) mounted on the shaft (20′), the compressor wheel (18′) including a backface (38′);
a bearing housing (23′), a portion of the shaft (20′) being received in the bearing housing (23′);
one or more seals (32′) operatively positioned in an interface (400) between one or more static turbocharger elements and the rotating assembly, whereby the one or more seals (32) minimize oil passage from the bearing housing across the interface (400); and
a generally annular pressure plate (92) operatively positioned between the backface (38′) of the compressor wheel (18′) and the bearing housing (23′), a volume (80) being defined between at least the pressure plate (92) and the bearing housing (23′), the volume (80) having a restricted flow outlet passage (91) comprising a labyrinth seal (90).

10. The sealing system of claim 9, further including a supply line (78) in fluid communication with the volume (80), whereby a pressurized fluid is selectively supplied to the volume (80) via the supply line (78) to maintain an inward directed pressure gradient across the interface (400) to prevent oil leakage from the bearing housing (23′).

11. The sealing system of claim 9, wherein the labyrinth seal (90) includes a plurality of teeth (100) formed in one of a compressor side surface (94) of the pressure plate (92) or the backface (38′) of the compressor wheel (18), and wherein a labyrinth chamber (102) is formed between neighboring pairs of teeth (100).

12. The sealing system of claim 9, wherein the labyrinth seal (90) includes a plurality of teeth (100) formed in the backface (38′) of the compressor wheel (18′) such that a labyrinth chamber (102) is formed between neighboring pairs of teeth (100),
wherein the labyrinth seal (90) further includes a plurality of teeth (100′) formed in a compressor side surface (94) of the pressure plate (92) such that a labyrinth chamber (102′) is formed between neighboring pairs of teeth (100′),
wherein each of the teeth (100) formed in the backface (38′) of the compressor wheel (18′) is received in a respective one of the labyrinth chambers (102′) in the compressor side surface (94) of the pressure plate (92), and
wherein each of the teeth (100′) formed in the compressor side surface (94) of the pressure plate (92) is received in a respective one of the labyrinth chambers (102) formed in the backface (38′) of the compressor wheel (18′).

13. A method of minimizing oil leakage from a bearing housing (23′) into the compressor end of a turbocharger (10′), the turbocharger (10′) including: one or more seals (32′) operatively positioned in an interface (400) between one or more static turbocharger elements and one or more rotating turbocharger elements, the interface (400) having an inboard side (300) and an outboard side (200), whereby the one or more seals (32′) minimize oil passage from the bearing housing across the interface (400), the method comprising:
selectively pressurizing the outboard side (200) of the interface (400) to maintain an inward directed pressure gradient across the interface (400).

14. The method of claim 13, wherein the selectively pressurizing occurs when the pressure on the outboard side (200) is determined to be at or below a predetermined target pressure.

15. The method of claim 13, wherein the selectively pressurizing includes supplying pressurized air to the outboard side (200) of the seal interface (400).
